(19) United States
(12) Patent Application Publication
(10) Pub. No.: US 2011/0052292 A1
(43) Pub. Date: Mar. 3, 2011

(54) TWO-SIDED IMAGE ON PAPER SKEW REGISTRATION

(75) Inventor: Saurabh Prabhat, Webster, NY (US)

(73) Assignee: Xerox Corporation, Norwalk, CT (US)

(21) Appl. No.: 12/550,533

(22) Filed: Aug. 31, 2009

(51) Int. Cl. G03G 15/00

(52) U.S. Cl. 399/395

(57) ABSTRACT

According to aspects illustrated herein, there is provided a method, a system, and a printmaking device for registering a sheet of paper. In the method, the sheet is transported in a process direction along the feed path and past a first and a second optical sensor to determine a first skew of a first edge of the sheet. Next, the first skew of the first edge is calculated using the first time interval, the first distance, and the first velocity. After that, the first skew is used to register a first side of the sheet prior to printing thereon. Then, the sheet is inverted and refed on a second side. Thereafter, the sheet is transported in the process direction along the feed path and past a third and a fourth optical sensor to determine a second skew of the first edge. Finally, the second skew is used to register the second side of the sheet prior to printing thereon.

### TECHNICAL FIELD

This disclosure generally relates to a method for determining an angular orientation positioning of an image on a sheet of printing material during two-sided printing, and a system for monitoring the angular orientation of an image on a sheet of printing material during two-sided printing.

### BACKGROUND

For precisely positioning an image on a sheet of printing material, it is necessary to monitor, and if necessary or desirable, to correct the position of the image. The precise position of an image on the sheet of printing material may be important when, for example, images are printed on both sides of the sheet.

Since the sheet gets inverted between printing on a first side and a second side the lead edge for the first side is the trail edge for the second side and the trail edge for the first side is the lead edge for the second side. By not registering the position of the sheet just before printing on both sides of the sheet using the appropriate side of the sheet, the first side to the second side image on paper registration may not match due to cut sheet tolerances and lead edge/trail edge non-parallelism.

There are other methods that eliminate the problem of using different reference edges for skew registration between the first side and the second side, such as using side edge sensing. Using the side edges can be difficult in center registered systems and even if a side edge registered system uses side edge sensors, the CCD (charge-coupled device) sensors are expensive and low cost CIS (contact image sensor) array sensors do not provide the proper resolution for an accurate registration. Therefore, it would be advantageous to provide a system and method for registering both sides of the sheet such that the first side to the second side image on paper registration matches.

### SUMMARY

According to aspects illustrated herein, there is provided a method for registering a sheet of paper along a feed path. The method begins by, moving the sheet in a process direction along the feed path and past a first optical sensor and a second optical sensor to determine a first skew of a first edge of the sheet. The first optical sensor and the second optical sensor being configured to determine: a first time interval, the first time interval being equal to time elapsed between the first edge of the sheet passing the first optical sensor and the second optical sensor; and a first distance, the first distance is a distance between the first optical sensor and the second optical sensor. Next, the method calculates a first velocity of the sheet along the feed path at the first time interval and the first skew of the first edge of the sheet using the first time interval, the first distance, and the first velocity. After that, the method uses the first skew to register a first side of the sheet prior to printing a first image on the first side of the sheet. Then, the method inverts and refeeds the sheet on a second side. Thereafter, the method moves the sheet in the process direction along the feed path and past a third optical sensor and a fourth optical sensor to determine a second skew of the first edge of the sheet, the third optical sensor and the fourth optical sensor being configured to determine a second time interval, the second time interval being equal to time elapsed between the second edge of the sheet passing the third optical sensor and the fourth optical sensor; and a second distance, the second distance is the distance between the third optical sensor and the fourth optical sensor. Subsequently, the method calculates a second velocity of the sheet and the second skew of the first edge of the sheet using the second time interval, the second distance, and the second velocity. Finally, the method uses the second skew to register the second side of the sheet prior to printing a second image on the second side of the sheet, with the registration aligning the first image on the first side of the sheet with the second image on the second side of the sheet.

According to other aspects illustrated herein, there is provided a system for registering a sheet of paper using a printmaking device. The system includes a feed path configured to move in a process direction; at least one pair of optical sensors; and a control module. The at least one pair of optical sensors are configured to measure a first position of a first edge of the sheet and a second position of a first edge of the sheet. The control module is configured to register a first side of the sheet by: determining a first time interval being equal to time elapsed between the first edge of the sheet passing the first optical sensor and the second optical sensor; determining a first distance between the first optical sensor and the second sensor; calculating a first velocity of the sheet along the feed path of the first time interval; and calculating a first skew using the first time interval, the first distance, and the first velocity. Next, the control module is configured to register a second side of the sheet by: determining a second time interval being equal to time elapsed between the first edge of the sheet passing the third optical sensor and the fourth optical sensor; determining a second distance between the third optical sensor and fourth optical sensor; calculating a second velocity of the sheet along the feed path at the second time interval; and calculating a second skew using the second time interval, the second distance, and the second velocity. Then, the system moves the sheet along the feed path and past the first optical sensors and the second optical sensor to determine the first skew of the first edge of the first side of the sheet. The control module uses the first skew to register the first side of the sheet prior to printing a first image on the first side of the sheet. After that, the sheet is refed on the second side and moves along the feed path and past the third optical sensor and the fourth optical sensor to determine the second skew of the first edge with respect to the second side of the sheet. Finally, the control module uses the second skew to register the second side of the sheet prior to printing a second image on the second side of the sheet. The registration by the control module aligns the first image on the first side of the sheet with the second image on the second side of the sheet.

According to other aspects illustrated herein, there is provided a printmaking device for registering a sheet of paper along a feed path. The printmaking device including a feed path, a printing module, and a two-sided deskewing system. The feed path is adapted to move a sheet of paper, the sheet including a first edge and a second edge, with the first edge being approximately parallel to the second edge. The printing module configured to print an image on the sheet. The two-sided deskewing system along the feed path including at least one pair of optical sensors and a control module. The at least one pair of optical sensors include a first optical sensor and a second optical sensor being configured to measure a first position of the first edge of the sheet. The at least one pair of optical sensors further include a third optical sensor and a fourth optical sensor being configured to measure a second position of the second edge of the sheet. The control module is configured to register a first side of the sheet and a second side of the sheet. As the feed path moves the sheet in a process direction past the first optical sensor and the second optical sensor and the control module registers the first side of the sheet, prior to printing the first image on the first side of the sheet. The control module registers the first side by: determining a first time interval being equal to time elapsed between the first edge of the sheet passing the first optical sensor and the second optical sensor; determining a first distance between the first optical sensor and second optical sensor; calculating a first velocity of the sheet along the feed path at the first time interval; and calculating a first skew using the first time interval, the first distance, and the first velocity. Next, the printmaking device inverts and refeeds the sheet on the second side, the feed path moves the sheet in the process direction and past the third optical sensor and the fourth optical sensor, and the control module registers the second side of the sheet, prior to printing the second image on the second side of the sheet, by: determining a second time interval being equal to time elapsed between the first edge of the sheet passing the third optical sensor and the fourth optical sensor; determining a second distance between the third optical sensor and the fourth sensor; calculating a second velocity of the sheet along the feed path at the second time interval; and calculating a second skew using the second time interval, the second distance, and the second velocity. The registration by the control module is configured to align a first image on the first side of the sheet with a second image on the second side of the sheet.

Additional features and advantages will be readily apparent from the following detailed description, the accompanying drawings, and the claims. It is to be understood, however, that the drawings are designed as an illustration only and not as a definition of the limits of the disclosure.

### BRIEF DESCRIPTION OF THE DRAWINGS

FIG. 1 illustrates a method for registering two sides of a sheet of paper along a feed path of a printmaking device using at least on pair of optical sensors.

FIG. 2 illustrates a system with two pairs of optical sensors for use with the method of FIG. 1, where the first side of the sheet is being registered.

FIG. 3 illustrates a system with two pairs of optical sensors for use with the method of FIG. 1, where the second side of the sheet is being registered.

FIG. 4 illustrates a system with one pair of optical sensors for use with the method of FIG. 1, where the first side of the sheet is being registered.

FIG. 5 illustrates a system with one pair of optical sensors for use with the method of FIG. 1, where the second side of the sheet is being registered.

FIG. 6 illustrates a printmaking device for use with the method and system shown in FIGS. 1-5.

Like reference symbols in the various drawings indicate like elements.

### DETAILED DESCRIPTION

The method and system disclosed herein provide for registering both sides of a sheet of paper along a feed path of a printmaking device to ensure that the positions of the images on both sides of the paper are aligned.

As used herein, the phrase “printmaking device” encompasses any apparatus, such as a digital copier, a bookmaking machine, a facsimile machine, and a multi-function machine, which performs a printing outputting function for any purpose.

As used herein, the term “sheet” encompasses, for example, one or more of a usually flimsy physical sheet of paper, heavy media paper, coated papers, transparencies, parchment, film, fabric, plastic, or other suitable physical print media substrate on which information can be reproduced.

As used herein, the phrase “feed path” encompasses any apparatus for separating and/or conveying one or more sheets into a substrate conveyance path inside a printmaking device.

As used herein, the phrase “process direction” refers to a direction that the feed path moves a sheet.

As used herein, the phrase “lead edge” refers to the edge of a sheet that first advances along the substrate conveyance path.

As used herein the phrase “printing module” refers to a marking device that uses marking technologies, such as xerographic, inkjet, and offset markings.

As used herein, the term “skew” refers to an angular error in the placement of an image printed onto a sheet.

As used herein, the phrase “optical sensors” refer to a sensor that detects the intensity or brightness of light.

As used herein, the phrase “fixed reference” refers the alignment and configuration of the sensor, which points at a non-changing location to where the sensor collects information. The reference is a fixed reference because the sensor will only detect activity at the configured location. For example, a fixed reference may be a specific location on the feed path and the sensor may detect when a sheet is at that specific location.

As used herein, the terms “register” and “registration” refer to determining the proper alignment of a sheet and/or a printing apparatus with respect to a fixed reference.

As used herein, the terms “invert,” “inverting,” and “inverted” refer to the action of reversing the position of the sheet, such as flipping the sheet from a first side to a second side.

As used herein, the terms “refeed,” “refeeding,” and “refed” refer to a sheet being conveyed on a feed path for a second time after first moving along the feed path and having an image printed thereon. For example, in a duplex printmaking device, a sheet is fed along the feed path a first time to print an image on a first side, and then the sheet is inverted and then refed along the feed path a second time to print another image on a second side.

As used herein, the phrase “time interval” refers to a time period between two events. For example, a time period between a sheet crossing a first sensor and a second sensor.

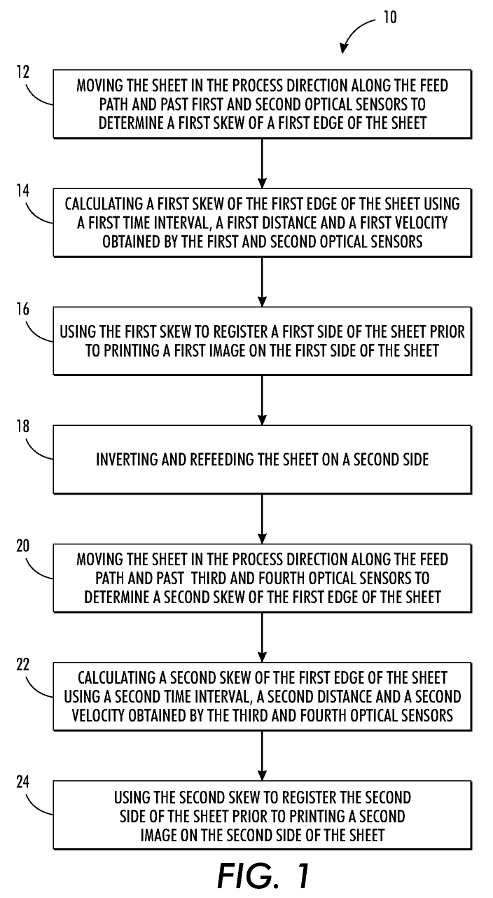

FIG. 1 provides a method 10 for registering both sides of a sheet of paper along a feed path of a printmaking device to ensure that the positions of the images on both sides of the paper are aligned. In step 12, the printmaking device moves the sheet in a process direction along the feed path and past a first optical sensor and a second optical sensor to determine a first skew of the first edge. A first skew of the first edge of the sheet is calculated by the control module in step 14. The first skew is calculated using a first time interval between a sheet crossing the first optical sensor and the second optical sensor, a first distance between the first optical sensor and the second optical sensor, and a first sheet velocity. Next, in step 16, the control module uses the first skew to register a first side of the sheet prior to printing a first image on the first side of the sheet.

After that, the printmaking device inverts the sheet and refeeds the sheet on a second side in step 18. Then, in step 20, the printmaking device moves the sheet in a process direction along the feed path and past a third optical sensor and a fourth optical sensor to determine a second skew of the first edge. The second skew of the first edge of the sheet is calculated by the control module in step 22. The second skew is calculated using a second time interval between the sheet crossing the third optical sensor and the fourth optical sensor, a second distance between the third optical sensor and the fourth optical sensor, and a second velocity. Finally, in step 24, the control module uses the second skew to register a second side of the sheet prior to printing a second image on the second side of the sheet.

The method 10 registers the first side of the sheet using skew information calculated using an equation that establishes the skew as substantially equal to v1*(t1−t2)/y1, where v1 is the first velocity, (t1−t2) is the first time interval, and y1 is the first distance. The method 10 then registers the second side of the sheet using skew information calculated using a similar equation that establishes the skew as substantially equal to v2*(t3−t4)/y2, where v2 is the second velocity, (t3−t4) is the second time interval, and y2 is the second distance.

The method 10 may use a printing module to print the first and second images on the first and second sides of the sheet. The method 10 may be modified to use one pair of optical sensors. In that case, the method 10 would use the first optical sensor and the second optical sensor to measure the skew of both the first and the second side of the sheet. Furthermore, the method may be configured such that the first edge is the lead edge of the first side of the sheet and the second edge is the trail edge of the first side of the sheet. Accordingly, the first edge is the trail edge of the second side of the sheet and the second edge is the lead edge of the second side of the sheet.

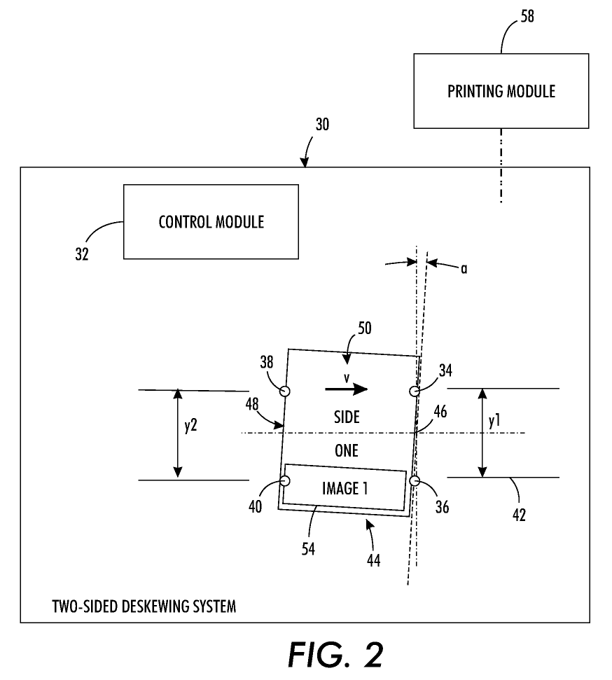

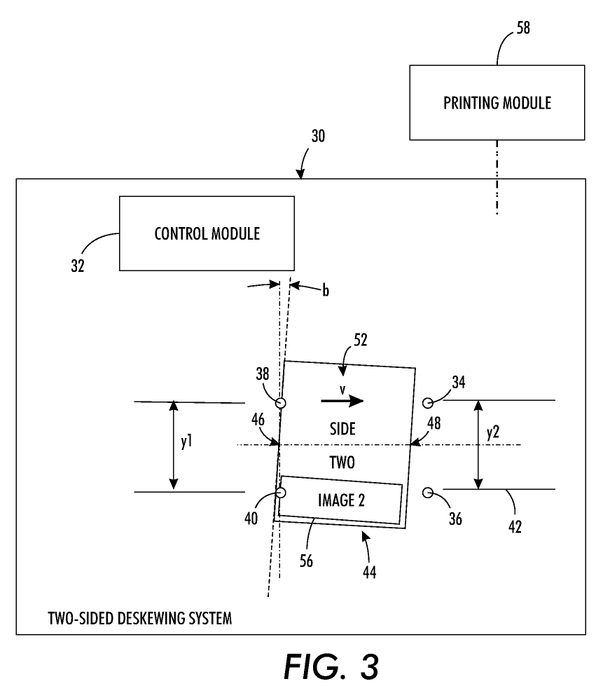

FIGS. 2-3 provide an exemplary system 30 for use with the method 10 of FIG. 1. The system 30 having a control module 32, a first and second pair of optical sensors including a first optical sensor 34, a second optical sensor 36, a third optical sensor 38, a fourth optical sensor 40, and a feed path 42 for registering a sheet 44 of paper. The sheet 44 having a first edge 46 and a second edge 48 with the first edge 46 and the second edge 48 being approximately parallel.

The first optical sensor 34 and the second optical sensor 36 are configured to measure a first position and determine a first skew a of the first edge 46 of a first side 50 of the sheet 44. The third optical sensor 38 and the fourth optical sensor 40 are configured to measure a first position and determine a second skew b of the first edge 46 of a second side 52 of the sheet 44.

The control module 32 is configured to register the first side 50 and the second side 52 of the sheet 44. The first side 50 of the sheet 44 is registered by determining a first time interval being equal to time elapsed between the first edge 46 of the sheet 44 passing the first optical sensor 34 and the second optical sensor 36; determining a first distance, y1, between the first optical sensor 34 and the second optical sensors 36; and calculating a first velocity of the sheet 44 along the feed path 42 during the first time interval. After that, the first skew a is calculated using the first time interval, the first distance, and the first velocity.

Similarly, after the sheet 44 is inverted and refed, the control module 32 registers the second side 52 of the sheet 44. The second side 52 of the sheet 44 is registered by determining a second time interval being equal to time elapsed between the first edge 46 of the sheet 44 passing the third optical sensor 38 and the fourth optical sensor 40; determining a second distance, y2, between the third optical sensor 38 and the fourth optical sensor 40; and calculating a second velocity of the sheet 44 along the feed path 42 during the second time interval. Then, the second skew b is calculated using the second time interval, the second distance, and the second velocity.

In operation, as the sheet 44 moves along a feed path 42 in a process direction v and past the first optical sensor 34 and the second optical sensor 36 to determine a first skew a of the first edge 46 of the sheet 44. Next, the control module 32 uses the first skew a to register the first side 50 of the sheet 44 prior to printing a first image 54 on the first side 50 of the sheet 44. To register the first side 50 of the sheet 44 the following equation is used to estimate the sheet skew: r1=v1*(t1−t2)/y1, where the first velocity is v1, the first time interval is (t1−t2), and the first distance is y1.

After that, the printmaking device inverts and refeeds the sheet 44 and moves the sheet 44 along the feed path 42 in the process direction v and past the third optical sensor 38 and the fourth optical sensor 40 to determine a second skew b of the first edge 46 of the sheet 44. Then, the control module 32 uses the second skew b to register the second side 52 of the sheet 44. The second side 52 of the sheet 44 is registered using the sheet skew estimated using the equation: r2=v2*(t3−t4)/y2, where the second velocity is v2, the second time interval is (t3−t4), and the second distance is y2. The registration of the first and second sides 50, 52 of the sheet 44 by the control module 32 is designed to properly align the first image 54 on the first side 50 of the sheet 44 with the second image 56 on the second side 52 of the sheet 44.

The system 30 of FIGS. 2-3 may further include a printing module 58 for printing the first image 54 on the first side 50 of the sheet 44 and the second image 56 on the second side 52 of the sheet 44. The type of printing module 58 contemplated may include any marking technology known to one of skill in the art for use with a system for duplex printing.

In FIGS. 2-3 the first edge 46 is the lead edge of the first side 50 of the sheet 44 in relation to the process direction v and the second edge 48 is the trail edge of the second side 52 of the sheet 44 after the sheet 44 is refed. The system 30 of FIGS. 2-3 is not limited to the first edge 46 being the lead edge of the first side 50 of the sheet 44. Thus, the first edge 46 may be the trail edge of the first side 50 of the sheet 44 and the second edge 48 may be the lead edge of the first side 50 of the sheet 44. An important aspect is that the system 30 uses the sensors to accurately determine the position of the same edge of the sheet 44 during registration of both sides.

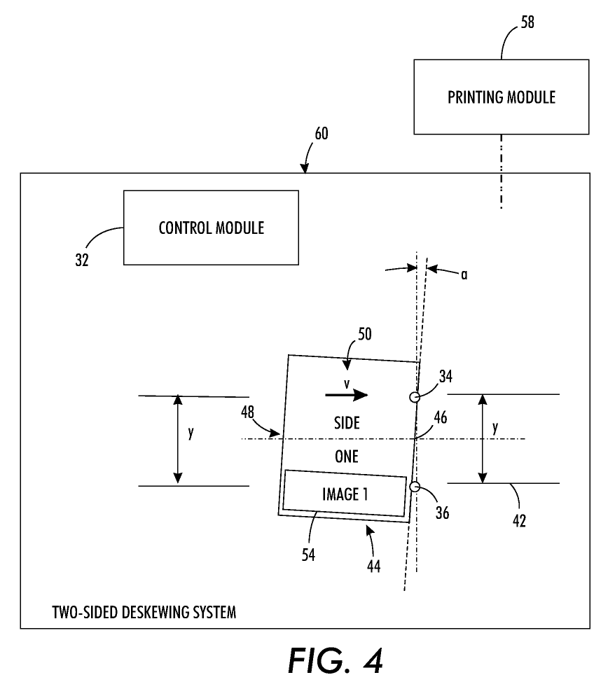

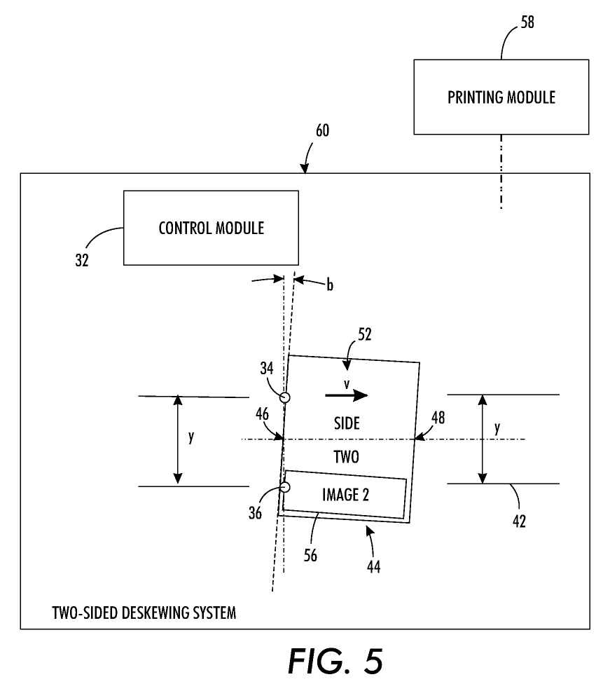

Referring to FIGS. 4-5, a further exemplary system 60 is provided. The system 60 of FIGS. 4-5 is a variation of the system 30 of FIGS. 2-3, for use with the method 10 of FIG. 1. The system 60 of FIGS. 4-5 uses one pair of optical sensors, the first optical sensor 34 and the second optical sensor 36 to register both the first and second sides 50, 52 of the sheet 44. In FIGS. 4-5, the first optical sensor 34 and the second optical sensor 36 determine the first skew a of the lead edge (first edge) of the first side 50 of the sheet 44 and the second skew b of the trail edge (first edge) of the second side 52 of the sheet 44. All other aspects of the system 60 are the same as the system 30 of FIGS. 2-3.

Alternatively, the system 60 of FIGS. 4-5 may use the first optical sensor 34 and the second optical sensor 36 to determine the first skew a of the trail edge (second edge) of the first side 50 of the sheet 44 and the second skew b based on the lead edge (second edge) of the second side 50 of the sheet 44.

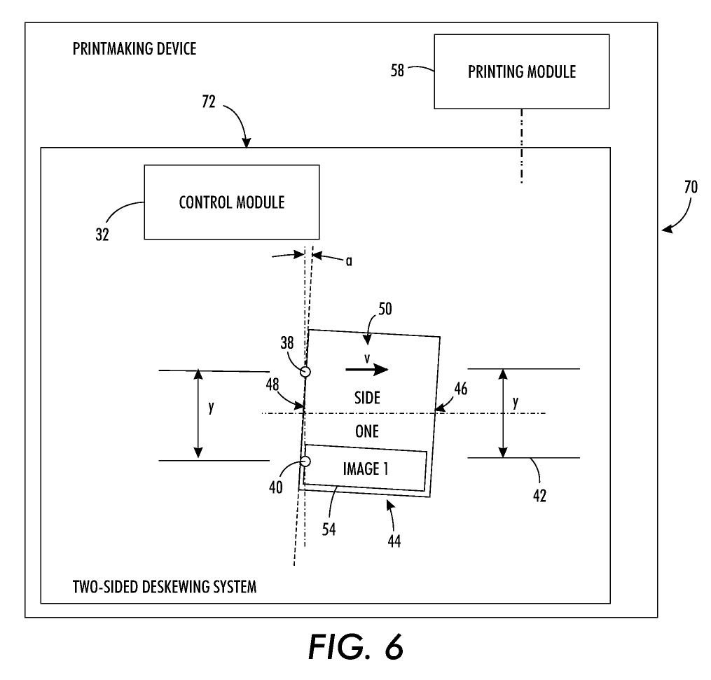

FIG. 6 provides a printmaking device 70 for use with the method 10 and systems 30, 60 of FIGS. 1-5. The printmaking device 70 includes a control module 32, feed path 42, a printing module 58, and a two-sided deskewing system 72, similar to that described in FIGS. 2-5.

The feed path 42 is adapted to move the sheet 44 in a process direction v. The sheet 44 having the first edge 46 and the second edge 48, with the first edge 46 and the second edge 48 being approximately parallel. The printing module 58 being configured to print the first image 54 on the first side 50 of the sheet 44 and the second image 56 on the second side 52 of the sheet 44 using any marking means known to those skilled in the art. The two-sided deskewing system 72 is along the feed path 42 and includes at least one pair of optical sensors and a control module 32. The at least one pair of optical sensors are shown as the third optical sensor 38 and the fourth optical sensor 40 in FIG. 6.

The control module 32 is configured to register a first side 50 and a second side 52 of the sheet 44. The first side 50 of the sheet 44 is registered by determining a first time interval being equal to time elapsed between the first edge 46 of the sheet 44 passing the third optical sensor 38 and the fourth optical sensor 40; determining a first distance between the third optical sensor 38 and the fourth optical sensor 40; and calculating a first velocity of the sheet 44 along the feed path 42 during the first time interval. After that, the first skew a is calculated using the first time interval, the first distance, and the first velocity.

Similarly, after the sheet 44 is inverted and refed, the control module 32 registers the second side 52 of the sheet 44. The second side 52 of the sheet 44 is registered by determining a second time interval being equal to time elapsed between the first edge 46 of the sheet 44 passing the third optical sensor 38 and the fourth optical sensor 40; determining a second distance between the third optical sensor 38 and the fourth optical sensor 40; and calculating a second velocity of the sheet 44 along the feed path 42 during the second time interval. Then, the second skew b is calculated using the second time interval, the second distance, and the second velocity.

In operation, as the sheet 44 moves along a feed path 42 in a process direction v and past the third optical sensor 38 and the fourth optical sensor 40 to determine a first skew a of the first edge 46 of the sheet 44. Next, the control module uses the first skew a to register the first side 50 of the sheet 44 prior to printing a first image 54 on the first side 50 of the sheet 44. To register the first side 50 of the sheet 44 the following equation is used to calculate the skew a: r1=v1*(t1−t2)/y1, where the first velocity is v1, the first time interval is (t1−t2), and the first distance is y1.

After that, the printmaking device 70 refeeds the sheet 44 and moves the sheet 44 along the feed path 42 in the process direction v and past the third optical sensor 38 and the fourth optical sensor 40 to determine a second skew b of the first edge 46 of the sheet 44. Then, the control module 32 uses the second skew b to register the second side 52 of the sheet 44. The second side 52 of the sheet 44 is registered using the skew b calculated using the equation: r2=v2*(t3−t4)/y2, where the second velocity is v2, the second time interval is (t3−t4), and the second distance is y2. The registration of the first and second sides 50, 52 of the sheet 44 by the control module 32 is designed to properly align the first image 54 on the first side 50 of the sheet 44 with the second image 56 on the second side 52 of the sheet 44.

Alternatively, the one pair of optical sensors may be the first optical sensor 34 and the second optical sensor 36 as shown and discussed with reference to FIGS. 4-5. A further variation of FIG. 6 includes using two pairs of optical sensors, the first optical sensor 34, the second optical sensor 36, the third optical sensor 38, and the fourth optical sensor 40, as shown and discussed in FIGS. 2-3.

The benefits of the method, system, and printmaking device provided herein include aligning images based on the skew for the same edge of both the first side 50 and the second side 52 of the sheet 44. Using the system and method provided herein eliminates the first side 50 to second side 52 image on paper registration errors caused by cut sheet tolerances and lead edge/trail edge non-parallelism. An additional benefit is that the system and method provided herein enable the use of low cost point sensors.

It will be appreciated that variations of the above-disclosed and other features and functions, or alternative thereof, may be desirably combined into many other different systems or applications. Various presently unforeseen or unanticipated alternatives, modifications, variations, or improvements therein may be subsequently made by those skilled in the art which are also intended to be encompassed by the following claims. In addition, the claims can encompass embodiments in hardware, software, or a combination thereof.

What is claimed is:

1. A method for registering a sheet of paper along a feed path of a printmaking device, comprising the steps of:
moving the sheet in a process direction along the feed path and past a first optical sensor and a second optical sensor to determine a first skew of a first edge of the sheet, said first optical sensor and said second optical sensor being configured to determine:
a first time interval, wherein said first time interval being equal to time elapsed between said first edge of the sheet passing said first optical sensor and said second optical sensor;
a first distance, wherein said first distance is a distance between said first optical sensor and said second optical sensor; and
calculating a first velocity of the sheet along the feed path at said first time interval;
calculating said first skew of said first edge of the sheet using said first time interval, said first distance, and said first velocity;
using said first skew to register a first side of the sheet prior to printing a first image on said first side of the sheet;
inverting and refeeding the sheet on a second side;
moving the sheet in said process direction along the feed path and past a third optical sensor and a fourth optical sensor to determine a second skew of said first edge of the sheet, said third optical sensor and said fourth optical sensor being configured to determine:
a second time interval, wherein said second time interval being equal to time elapsed between said first edge of the sheet passing said third optical sensor and said fourth optical sensor;
a second distance, wherein said second distance is said distance between said third optical sensor and said fourth optical sensor; and
calculating a second velocity of the sheet;
calculating said second skew of said first edge of the sheet using said second time interval, said second distance, and said second velocity; and
using said second skew to register said second side of the sheet prior to printing a second image on said second side of the sheet;
wherein registration aligns said first image on said first side of the sheet with said second image on said second side of the sheet.

2. The method of claim 1, wherein said first skew of the sheet is substantially equal to v1*(t1−t2)/y1, where said first velocity is v1, said first time interval is (t1−t2), and said first distance is y1.

3. The method of claim 1, wherein said second skew of the sheet is substantially equal to v2*(t3−t4)/y2, where said second velocity is v2, said second time interval is (t3−t4), and said second distance is y2.

4. The method of claim 1, wherein said first optical sensor and said third optical sensor are the same sensor and said second optical sensor and said fourth optical sensor are the same sensor.

5. The method of claim 1, wherein a printing module prints said first image on said first side of the sheet and said second image on said second side of the sheet.

6. The method of claim 1, wherein said first edge is a trail edge of said first side of the sheet and said first edge is a lead edge of said second side of the sheet.

7. The method of claim 1, wherein said first edge is a lead edge of said first side of the sheet and said first edge is a trail edge of said second side of the sheet.

8. A system for use with a printmaking device to register a sheet of paper comprising:
a feed path configured to move in a process direction;
at least one pair of optical sensors, wherein said at least one pair of optical sensors are configured to measure a first position of a first edge of the sheet and a second position of a first edge of the sheet; and
a control module configured to:
register a first side of the sheet by:
determining a first time interval being equal to time elapsed between said first edge of the sheet passing said first optical sensor and said second optical sensor;
determining a first distance between said first optical sensor and said second optical sensors;
calculating a first velocity of the sheet along said feed path of said first time interval; and
calculating a first skew using said first time interval, said first distance, and said first velocity;
register a second side of the sheet by:
determining a second time interval being equal to time elapsed between said second edge of said sheet passing said third optical sensor and said fourth optical sensor;
determining a second distance between said third optical sensor and fourth optical sensor;
calculating a second velocity of the sheet along said feed path at said second time interval; and
calculating a second skew using said second time interval, said second distance, and said second velocity;
wherein the sheet moves along said feed path and past said first optical sensors and said second optical sensor to measure said first position and determine said first skew of said first edge of said first side of the sheet, and said control module uses said first skew to register said first side of the sheet prior to printing a first image on said first side of the sheet; wherein the sheet is inverted and refed on said second side and moves along said feed path and past said third optical sensor and said fourth optical sensors to measure said second position and determine said second skew of said first edge with respect to said second side of the sheet, and said control module uses said second skew to register said second side of the sheet prior to printing a second image on said second side of the sheet; and wherein registration by said control module aligns said first image on said first side of the sheet with said second image on said second side of the sheet.

9. The system of claim 8, wherein said first edge is a trail edge of said first side of the sheet and said first edge is a lead edge of said second side of the sheet.

10. The system of claim 8, wherein said first edge is a lead edge of said first side of the sheet and said first edge is a trail edge of said second side of the sheet.

11. The system of claim 8, wherein said first skew of the sheet is substantially equal to v1*(t1−t2)/y1, where said first velocity is v1, said first time interval is (t1−t2), and said first distance is y1.

12. The system of claim 8, wherein said second skew of the sheet is substantially equal to v2*(t3−t4)/y2, where said second velocity is v2, said second time interval is (t3−t4), and said second distance is y2.

13. The system of claim 8, wherein said first optical sensor and said third optical sensor are the same sensor and said second optical sensors and said fourth optical sensor are the same sensor.

14. The system of claim 8, further comprising a printing module for printing said first image on said first side of the sheet and said second image on said second side of the sheet.

15. A printmaking device comprising:
a feed path adapted to move a sheet of paper, said sheet including a first edge and a second edge, wherein said first edge is approximately parallel to said second edge;
a printing module configured to print an image on said sheet; and
a two-sided deskewing system along said feed path including at least one pair of optical sensors and a control module;
said at least one pair of optical sensors include a first optical sensor and a second optical sensor being configured to measure a first position of said first edge of said sheet;
said at least one pair of optical sensors further include a third optical sensor and a fourth optical sensor being configured to measure a second position of said first edge of said sheet; and
said control module is configured to register a first side of said sheet and a second side of said sheet;
wherein said feed path moves said sheet in a process direction past said first optical sensor and said second optical sensor and said control module registers said first side of said sheet, prior to printing said first image on said first side of said sheet, by:
determining a first time interval being equal to time elapsed between said first edge of said sheet passing said first optical sensor and said second optical sensor;
determining a first distance between said first optical sensor and second optical sensor;
calculating a first velocity of said sheet along said feed path at said first time interval; and
calculating a first skew using said first time interval, said first distance, and said first velocity;
wherein said printmaking device inverts and refeeds said sheet on said second side, said feed path moves said sheet in said process direction and past said third optical sensor and said fourth optical sensor, and said control module registers said second side of said sheet, prior to printing said second image on said second side of said sheet, by:
determining a second time interval being equal to time elapsed between said first edge of said sheet passing said third optical sensor and said fourth optical sensor;
determining a second distance between said third optical sensor and said fourth sensor;
calculating a second velocity of said sheet along said feed path at said second time interval; and
calculating a second skew using said second time interval, said second distance, and said second velocity.
wherein registration by said control module is configured to align a first image on said first side of said sheet with a second image on said second side of said sheet.

16. The printmaking device of claim 15, wherein said first edge is a trail edge of said first side of said sheet and said first edge is a lead edge of said second side of said sheet.

17. The printmaking device of claim 15, wherein said first edge is a lead edge of said first side of said sheet and said first edge is a trail edge of said second side of said sheet.

18. The printmaking device of claim 15, wherein said first skew of said sheet is substantially equal to v1*(t1−t2)/y1, where said first velocity is v1, said first time interval is (t1−t2), and said first distance is y1.

19. The printmaking device of claim 15, wherein said second skew of said sheet is substantially equal to v2*(t3−t4)/y2, where said second velocity is v2, said second time interval is (t3−t4), and said second distance is y2.

20. The printmaking device of claim 15, wherein said first optical sensor and said third optical sensor are the same sensor and said second optical sensors and said fourth optical sensor are the same sensor.

21. The printmaking device of claim 15, wherein the printing module prints said first image on said first side of said sheet and said second image on said second side of said sheet.
